(19) United States
(12) Patent Application Publication
(10) Pub. No.: US 2010/0024627 A1
(43) Pub. Date: Feb. 4, 2010

(54) PROCESS FOR AND AUTOMATED PAGE FLIPPING DEVICE AND PRODUCTS THEREBY

(76) Inventor: Brian G. Choi, Irvine, CA (US)

Correspondence Address: Brian G. Choi, 58 Emerald, Irvine, CA, 92614, US

(21) Appl. No.: 12/510,770

(22) Filed: Jul. 28, 2009

Related U.S. Application Data
(60) Provisional application No. 61/084,230, filed on Jul. 28, 2008.

(51) Int. Cl. G10G 7/00

(52) U.S. Cl. 84/487; 84/486; 84/502

(57) ABSTRACT

Systems for automated page turning allow users, for example musicians, to review successive pages of data, such as sheet music, and homologues, without use of their hands. Mechanical and electronic solutions enable users to actuate controllers and have pages turned in an automated fashion, including moving forward and backward to capture desired views of select aspect of the involved data, such as a particular page of music.

### BACKGROUND OF THE DISCLOSURES

1. Field

The present invention relates to systems for allowing users to reach subsequent pages automatically during activities requiring at least a hand of a user where such activities are related to scanning and interpreting data, such as musical notes, traditionally arrayed in fixed packet lengths, such as pages. In particular, the present invention relates to turning music sheets or pages in a music book for musicians, for example, playing the piano.

### SUMMARY OF THE DISCLOSURE

An improved page turning device allows, for example, a musician playing musical instruments needing both hands, to have page flipping capacity either in an automatic manner or to be done in a facile way electronically.

Briefly stated, systems for automated page turning allow musicians to review sheet music and homologues, without use of their hands. Mechanical and electronic solutions enable users to actuate controllers and have pages turned in an automated fashion, so that their hands can remain focused on enumerated tasks.

According to embodiments a process for automatically turning pages includes providing an integrated mechanism comprised of at least a command input device and communicatively linked a page flipping device actuating the integrated mechanism, and repeating the actuating step or reversing the actuation step.

According to embodiments, an automatic page turning device for musical applications with at least a command input device, a page flipping mechanism and means for operatively linking the command input device with the page flipping mechanism.

According to the embodiments, there is disclosed an automatic page turning device kit comprised of directions for use, the device and any desired accoutrements.

According to embodiments, there is provided a page turning mechanism which consists of a command input device and a page flipping device. A musician uses the command input device to issue flip forward a page or flip backward a page commands to the page-flipping device. The page turning mechanism and associated device in turn will do the actual turning to the next page or turning to the previous page. There are within the scope of the instant teachings, different ways to implement this concept. At least two example embodiments are illustrated and claimed below.

### BRIEF DESCRIPTION OF THE FIGURES

The above-mentioned features and objects of the present disclosure will become more apparent with reference to the following description taken in conjunction with the accompanying drawings wherein like reference numerals denote like elements and in which:

FIG. 1 is a schematic showing the functional aspects of the disclosure of an embodiment of the teachings of the present disclosure; and

FIG. 2 is likewise schematically illustrates operations according to an embodiment of the present disclosure.

### DETAILED DESCRIPTION OF THE DISCLOSURE

The present inventor has solved the problem of how to turn pages during an activity which requires the user of one or both hands. For example, a pianist playing piano needs to access serially arranged and successive pages of music.

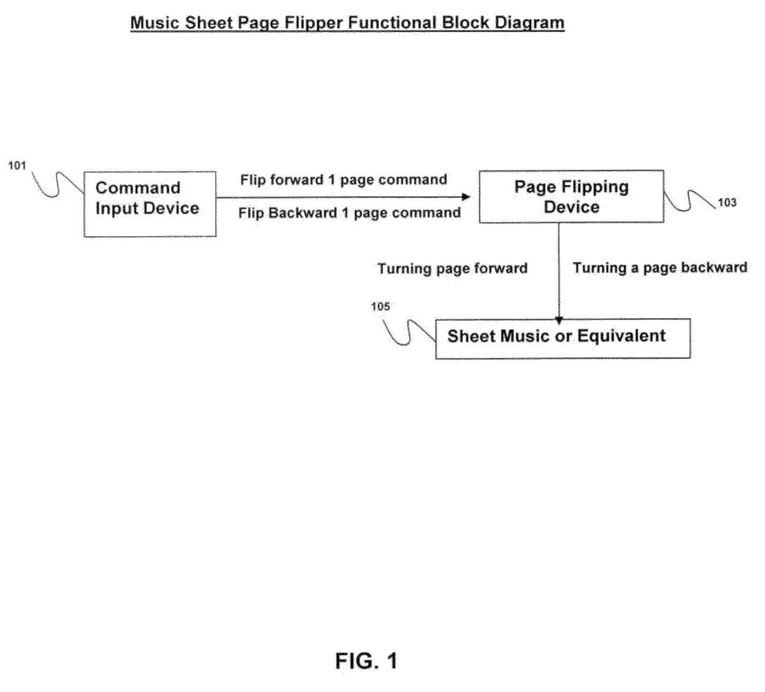

Referring now to FIG. 1, an overall schematic shows how the instant system work. For example, according to embodiments there is provided command input device, as shown in FIG. 1, instantiated as two foot pedals that a musician can step on with his/her foot to issue a “flip forward 1 page” and a “flip backward 1 page” command respectively to page flipping device 103.

The connection of foot pedals 101 to page flipping device 103 can be wired or wireless. For wired implementation, stepping on pedal 101 sends a unique signal through the wire to page flipping device 103. For wireless implementation, command input device 101 has a wireless transmitter that transmits radio signals out while page flipping device 101 has a wireless transmitter that transmit radio signals out while page flipping device 103 has a wireless receiver to receive these signals.

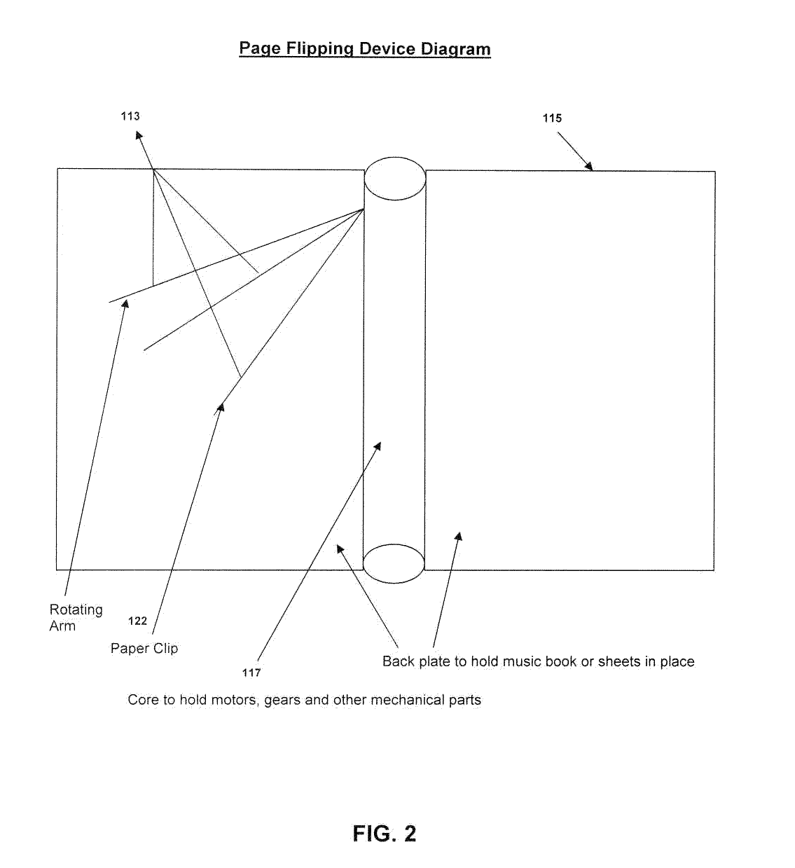

Turning now to FIG. 2, a mechanical manifestation of the instant system is shown. Artisans understand this basic embodiment can be constructed with parts, known and later developed components, and other readily substituted articles. This embodiment also works for conventional book-type of assemblies, binders, and other collected data-strings in hard copy.

### EXAMPLE 1

### Page Flipping Device

Referring to FIG. 2, page flipping device 111 should have as many rotating arms 113 as the number of pages to be turned. Each arm has at least two clips 122 that can be slid along arm 113 to fit the width of the page. Clips 122 are used to clip onto one page of music, each according to the illustrated example.

When the first flip forward 1 page command is sent to page flipping device 103, it will rotate a first arm 113 by 180 degrees anti-clockwise. In essence, this rotation turns a page forward. When a second flip forward 1 page command is received, it will rotate a second arm 113 and so on. A stepping motor can achieve the rotation. When a flip backward 1 page command is received, it will rotate a front arm 113 on the right clockwise 180 degrees to flip the page back. Basically, reversing the polarities of the power supply to the motor will cause it to rotate in a reverse direction. Please note that the turning of 180 degrees may be too much depending on the relative thickness of the music, or other book. 170 degrees may be enough in certain case, and another solution is to stop the turning with a friction sensor. These are just implementation details as known to those skilled in the art, all of which are within the scope of the teachings of the present invention.

### EXAMPLE 2

### Page Flipping Device

According to the instant teachings, yet another way to implement the page-flipping device is using something similar to a “digital picture frame” but a much simpler version. This device utilizes scanning means as well.

First, the music sheets have to be scanned into a series of numbered JPEG image files in a specific folder or all contained in one PDF file. For example, the song “Hi” with 5 pages can be stored in a folder called “Hi” with 5 JPEG files with the name of 001.JPG, 002.JPG, 003.JPG, 004.JPG and 005.JPG. Alternately, it can all be stored inside a 5-page PDF file named HI.PDF, a zip file or other storage means.

Referring again to FIG. 1, Page Flipping Device 103 has a digital picture frame in portrait orientation. The size of this picture area is implementation dependent. For example, it can be 8.5″W×11″H. Initially, the first page is displayed. When the first flip forward 1 page command is received, it will display the second page and so on. If a flip backward 1 page command is received, it will just display the previous page.

This device is a simplified version of a digital picture frame with two remote control commands to go to the next page and to go to the previous page. The scanning function can be an external scanner. For a luxury version of this product, it can include the scanning function. The file storage device can be a SD Flash Memory Card.

While the method and agent have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. A process for automatically turning pages, comprising, in combination:
providing an integrated mechanism further comprised of at least a command input device, and communicatively linked thereto a page flipping device:
actuating the integrated mechanism, and repeating the actuating step; or reversing the actuation step.

2. The process of claim 1, further comprised of pedals as the command input device, which functions as a two-function remote controlling of the pages mechanism.

3. An automatic page turning device for musical applications, comprising, in combination:
at least a command input device;
a page flipping mechanism; and
means for operatively linking the at least a command input device with the page flipping mechanism.

4. The automatic device of claim 3, further comprising a plurality of paper clips, at least three rotating arms, a back plate to hold music sheets or a book in place and a core element comprised of motors, gears and related mechanical parts, to turn the subject pages.

5. A kit, comprised of a device defined by claims 1, 3 and 4; and,
directions for use.

6. An electronic page turning system, comprising, in combination:
a scanned array of data; and
means for moving successive pieces of the data serially through a viewer;
whereby a user selects at least one command from the group consisting of go to the next page and go to the prior page, to enable serially stored data to be reviewed in a desired sequence.

7. The system of claim 1 or 6, further comprising at least one data set from the group consisting of sheet music and music books for a piano.
